(19) United States
(12) Patent Application Publication
(10) Pub. No.: US 2012/0001986 A1
(43) Pub. Date: Jan. 5, 2012

(54) Nozzle plate and method for manufacturing the nozzle plate, and inkjet printer head with the nozzle plate

(75) Inventor: Young Jae Kim, Gyeonggi-do (KR)

(73) Assignee: SAMSUNG ELECTRO-MECHANICS CO., LTD., Suwon (KR)

(21) Appl. No.: 12/926,188

(22) Filed: Oct. 29, 2010

(30) Foreign Application Priority Data
Jul. 1, 2010 (KR) 10-2010-0063316

(51) Int. Cl. B41J 2/14; B41J 2/16

(52) U.S. Cl. 347/47; 216/36

(57) ABSTRACT

The present invention provides a nozzle plate, the nozzle plate including: a first silicon substrate; and a second silicon substrate which has a crystal orientation different from that of the first silicon substrate and is bonded to the first silicon substrate, wherein the first silicon substrate includes a first through hole, and the second silicon substrate includes a second through hole which the first through hole communicates with, and has a different structure from that of the first through hole.

### CROSS-REFERENCE TO RELATED APPLICATIONS

This application claims the benefit of Korean Patent Application No. 10-2010-0063316 filed with the Korea Intellectual Property Office on Jul. 1, 2010, the disclosure of which is incorporated herein by reference.

### BACKGROUND OF THE INVENTION

1. Field of the Invention

The present invention relates to a nozzle plate and a method for manufacturing the nozzle plate, and an inkjet printer head with the nozzle plate; and, more particularly, to a nozzle plate for improving a discharge precision of ink, and a method for manufacturing the nozzle plate, and an inkjet printer head with the nozzle plate.

2. Description of the Related Art

At present, there has been widely used a technology for implementing images through an inkjet printer. A research has recently been conducted to apply the inkjet printer technology to processes for manufacturing a color filter, a solar cell battery, an OLED, and a PCB. The inkjet printer has an inkjet printer head for discharging ink. The inkjet printer head is largely provided with a nozzle package and a nozzle plate. The nozzle plate is formed on a lower portion of the nozzle package and accurately discharges ink in the last stage.

The inside of the nozzle package is provided with a plate laminate for defining a supply channel through which ink flows. And, the nozzle plate has a discharge channel for discharging ink received from the supply channel in the last stage. In general, the nozzle plate is manufactured by performing a wet-etching process to form a discharge channel described above on a silicon substrate. For example, the manufacture of the nozzle plate is made by forming through holes on the silicon substrate through a wet-etching process using a predetermined etching solution. At this time, the discharge channel is formed such that its upper opening has a larger diameter than that of its lower opening. Thus, the discharge channel may have various shapes whose cross sections get narrow downwardly, including a square pillar, a cylinder, a cone, and so on.

However, in case where the nozzle plate is formed using the wet-etching process, there is a limit in precisely forming the discharge channel. In particular, in case where the discharge channel is formed using the etching process in this way, the end of the discharge channel is formed to be sharp. If the discharge channel is used in an inkjet printer head to be completely formed, there may be a problem in that the discharge precision of ink output from the inkjet printer head is deteriorated.

According to a recent trend to increase a discharge precision of ink, the nozzle plate has discharge channels with at least two different shapes. For example, the discharge channel may be constructed to be usually a funnel shape with an inclined upper channel and a vertical lower channel. However, it is actually difficult to form the discharge channel with the above-structure by performing a precise control through a wet-etching process. Therefore, there is a problem such as a high defective rate of the manufactured nozzle plate.

### SUMMARY OF THE INVENTION

The present invention has been proposed in order to overcome the above-described problems and it is, therefore, an object of the present invention to provide a nozzle plate for improving a discharge precision of ink, and an inkjet printer head with the nozzle plate.

Further, another object of the present invention is to provide a method for manufacturing a nozzle plate for improving a discharge precision of ink.

Further, another object of the present invention is to provide a method for manufacturing a nozzle plate in which a discharge channel can discharge ink to the outside in the last stage.

In accordance with one aspect of the present invention to achieve the object, there is provided a nozzle plate including: a first silicon substrate; and a second silicon substrate which has a crystal orientation different from that of the first silicon substrate and is bonded to the first silicon substrate, wherein the first silicon substrate includes a first through hole, and the second silicon substrate includes a second through hole which the first through hole communicates with, and has a different structure from that of the first through hole.

Also, the first silicon substrate is disposed to be upper than the second silicon substrate, the first silicon substrate being a [100] silicon wafer, and the second silicon substrate being a [110] silicon wafer.

Also, the first through hole has a pillar shape whose cross section gets narrower downwardly, and the second through hole has the same upper and lower cross sections.

Also, the second silicon substrate has a thinner thickness than that of the first silicon substrate.

Also, the first through hole and the second through hole are structured to be in a funnel shape.

Also, the nozzle plate further includes a bonding layer interposed between the first silicon substrate and the second silicon substrate.

In accordance with other aspect of the present invention to achieve the object, there is provided a nozzle plate including: a first silicon substrate; a second silicon substrate which has a crystal orientation different from that of the first silicon substrate and is bonded to the first silicon substrate; and a discharge channel which passes through the first and second silicon substrates and has mutually different shapes with respect to a boundary surface between the first and second silicon substrates.

Also, the first silicon substrate is a [100] silicon wafer, and the second silicon substrate is a silicon wafer.

Also, the discharge channel includes: a first through hole which is formed through the first silicon substrate and has a cross section getting narrower downwardly; and a second through hole which is formed through the second silicon substrate, and communicates with the first through hole and has the same upper and lower cross sections.

Also, the second silicon substrate has a thinner thickness than that of the first silicon substrate.

Also, the discharge channel includes: a first thorough hole which is formed through the first silicon substrate; and a second through hole which is formed through the second silicon substrate, and communicates with the first through hole, wherein the first and second through holes are structured to be in a funnel shape.

In accordance with other aspect of the present invention to achieve the object, there is provided a method for manufacturing a nozzle plate including the steps of: preparing a plate structure by bonding silicon plates with mutually different crystal orientations; forming an anti-etching pattern, which exposes a desired region for formation of a discharge channel, on the plate structure; forming the discharge channel on the plate structure by performing a wet-etching process using the anti-etching pattern as an etching mask; and removing the anti-etching pattern.

Also, the step of preparing the plate structure includes the steps of: preparing a first silicon plate with a [100] crystal orientation; preparing a second silicon plate with a [110] crystal orientation; and bonding the first silicon plate to the second silicon plate.

Also, the step of preparing the plate structure includes the steps of: preparing the first and second plates with mutually different crystal orientations from each other; and bonding the first and second silicon plates in a Silicon Direct Bonding (SDB) scheme.

Also, the step of preparing the plate structure includes the step of bonding the silicon plates by using a bonding layer interposed therebetween.

Also, the step of forming an anti-etching pattern includes the steps of: forming a silicon nitride film which covers the plate structure; and selectively removing the silicon nitride film on a desired region for formation of the discharge channel.

Also, the step of forming the discharge channel includes the steps of: providing a first through hole formed through a silicon plate which is disposed to be upper among the silicon plates constituting the plate structure; and providing a second through hole formed through a silicon plate which is disposed to be lower among the silicon plates, the second through hole communicating with the first through hole and having a different structure from that of the first through hole.

Also, the step of forming the discharge channel includes a step of forming a through hole with a funnel shape which penetrates the plate structure.

Also, the step of preparing the preparing the plate structure includes the step of: preparing a first silicon plate with a [100] crystal orientation; and preparing a second silicon plate with a [110] crystal orientation, wherein the step of forming the discharge channel includes the steps of: providing a first through hole formed through the first silicon plate, the first through hole having a cross section which gets narrower downwardly; and providing a second through hole formed through the second silicon plate, the second through hole communicating with the first through hole and having the same upper and lower cross sections.

Also, the step of forming the discharge channel includes the steps of: providing the first through hole which is formed through a silicon plate which is disposed to be upper from the silicon plates constituting the plate structure in such a manner that a silicon plate disposed to be relatively low is exposed; and providing the second through hole which is formed through the lower-disposed silicon plate to communicate with the first through hole, by using the upper-disposed silicon plate as an etching mask.

Also, the step of preparing the plate structure includes a step of adjusting relative thicknesses of the silicon plates, the step of adjusting the relative thicknesses of the silicon plates including a step of grinding at least one of the silicon plates.

Also, the step of forming the discharge channel includes a step of supplying an etching solution which etches the plate structure to be anisotropic.

Also, the step of supplying the etching solution includes a step of supplying a KOH etching solution, the KOH etching solution etching the plate structure in such a manner that the anti-etching pattern covering a lower surface of the plate structure is exposed.

Also, the step of forming the discharge channel includes the steps of: providing the first through hole formed through the upper-disposed silicon plate, by etching the silicon plate which is disposed to be upper from the silicon plates of the plate structure; and providing the second through hole formed through the lower-disposed silicon plate from the silicon plates as the etching is self-aligned by the upper-disposed silicon plate.

In accordance with other aspect of the present invention to achieve the object, there is provided a method for manufacturing a nozzle plate including the steps of: preparing a plate structure constituted by silicon pates with mutually different crystal orientations; and forming a discharge channel, which has mutually different shapes with respect to a boundary surface between the first and second silicon plates, in the plate structure.

Also, the step of forming the discharge channel includes the steps of: forming an anti-etching pattern which exposes a desired region for formation of the discharge channel, on the plate structure; and performing a wet-etching process which uses the anti-etching pattern as an etching mask.

Also, the discharge channel includes a upper channel and a lower channel whose shapes are different from each other, the step of forming the discharge channel comprising a step of defining a boundary between the upper and lower channels, and the step of defining the boundary between the upper and lower channels being made by adjustment of relative thicknesses of the silicon plates.

Also, the plate structure includes a first silicon plate and a second silicon plate which are boned one on the other, the step of forming the discharge channel comprising the steps of:

providing a first through hole formed through the first silicon plate, the first through hole having a cross section which gets narrower toward the second silicon plate; and

providing a second through hole formed through the second silicon plate, the second through hole having the same upper and lower cross sections.

In accordance with other aspect of the present invention to achieve the object, there is provided an inkjet printer head including: a multi-layered plate structure which has spaces for defining supply channels through which ink flows therein; an actuator disposed on an upper portion of the multi-layered plate structure; a nozzle plate disposed an lower portion of the multi-layered plate structure, wherein the nozzle plate includes: a first silicon substrate; a second silicon substrate which has a crystal orientation different from that of the first silicon substrate and is bonded to the first silicon substrate; and a discharge channel which passes through the first and second silicon substrates and has mutually different shapes with respect to a boundary surface between the first and second silicon substrates.

Also, the first silicon substrate is a [100] silicon wafer, and the second silicon substrate is a [110] silicon wafer.

Also, the first silicon substrate has a first through hole having cross section which gets narrower downwardly, and the second silicon substrate has a second through hole which communicates with the first through hole and has the same upper and lower cross sections.

Also, the first silicon substrate includes a first through hole for defining an upper channel of the discharge channel, and the second silicon substrate includes a second through hole for defining a lower channel of the discharge channel, wherein the first and second through holes are formed in a funnel shape and communicates with each other.

Also, any one substrate disposed to be relatively low in the first and second silicon substrates has a thin thickness.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing an inkjet printer head in accordance with an embodiment of the present invention;

FIG. 2 is a view showing the nozzle plate shown in FIG. 1;

FIG. 3 is a flowchart showing a method for manufacturing a nozzle plate in accordance with an embodiment of the present invention; and

FIGS. 4 to 9 are views showing a process of manufacturing a nozzle plate in accordance with an embodiment of the present invention, respectively.

### DETAILED DESCRIPTION OF THE PREFERABLE EMBODIMENTS

The invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, a nozzle plate, a method for manufacturing the nozzle plate, and an inkjet printer head with the nozzle plate in accordance with an embodiment of the present invention will be described in more detail with reference to the accompanying drawings.

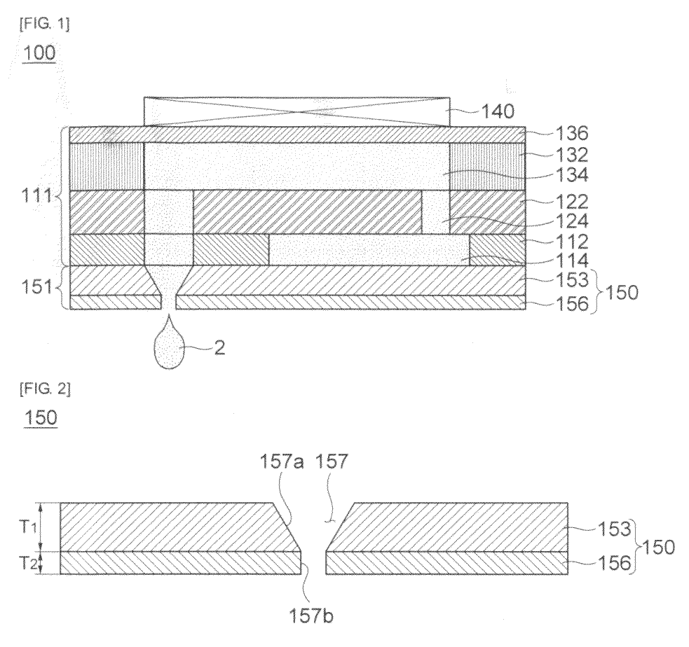

FIG. 1 is a view showing an inkjet printer head in accordance with an embodiment of the present invention. FIG. 2 is a view showing a nozzle plate shown in FIG. 1.

Referring to FIGS. 1 and 2, the inkjet printer head 100 of the present invention may include a nozzle package and a nozzle plate 150 coupled to the nozzle package.

The nozzle package may include a multi-layered plate structure 111, and an actuator 140. The multi-layered plate structure 111 may include a structure where a plurality of plates is sequentially stacked. For example, the multi-layered plate structure 111 may include a first plate 112, a second plate 122, and a third plate 132. The first plate 112 may be disposed on the lowermost portion of the multi-layered plate structure 111. The first plate 112 may include a through hole which defines a reservoir 114 to receive ink 2. The second plate 122 may be interposed between the first plate 112 and the third plate 132. The second plate 122 may include a through hole for defining a first supply channel 124 through which the ink 2 is supplied to the nozzle plate 150. The third plate 132 may be disposed on an upper portion of the second plate 122. The third plate 132 may include a through hole for defining the supply channel 134 through which the ink 2 is supplied, together with the uppermost protection plate 136 and the second plate 122.

As such, in the multi-layered plate structure 111 made with the first to third plates 112, 122 and 132, it is possible to define supply channels through which the ink 2 flowing therewithin is supplied to the nozzle plate 150. The supply channels may be spaces formed by the reservoir 114, the first supply channel 124, and the second supply channel 134.

The actuator 140 may be disposed on the upper portion of the multi-layered plate structure 111. The actuator 140 may be a driving means comprised of electrodes and piezoelectric interposed between the electrodes. When the ink 2 is supplied, the actuator 140 with the above-described structure applies a voltage to the electrodes, and thus it actuates the piezoelectric to expand the supply channels in the multi-layered plate structure 111, so that the ink 2 may be provided a pressure for ink's flow.

The nozzle plate 150 may include a multi-layered substrate structure 151. The multi-layered substrate structure 151 may have a structure where a plurality of substrates is boned on top of each other. For example, the multi-layered substrate structure 151 may include a first silicon substrate 153 and a second silicon substrate 156 which are bonded to each other.

The first silicon substrate 153 may be provided with a first through hole 157a. The first through hole 157a may be formed in a shape where its cross section gets narrower downwardly. That is, an upper opening of the first through hole 157a may have a width larger than that of a lower opening in a second through hole 157b. Thus, the first through hole 157a may be generally formed in at least one of shapes whose cross sections get narrower downwardly, including a square pillar, cylinder, a cone, and so on. The second silicon substrate 156 may have the second through hole 157b with which the first through hole 157a communicates. The second through hole 157b may have the same upper and lower cross sections. That is, the width of the upper opening of the second through hole 157b may be the same as that of the lower opening of the second through hole 157b. Thus, the second through hole 157b may be generally formed in one shape of a square pillar and cylinder.

The first through hole 157a and the second through hole 157b may constitute the discharge channel 157 with a funnel shape. That is, the first through hole 157a may define the upper channel of the discharge channel 157, whereas the second through hole 157b may define the lower channel of the discharge channel 157. The discharge channel 157 may correspond to a component for discharging the ink 2 supplied from the nozzle package to the outside in the last stage. Herein, the second silicon substrate 156 may have a thinner thickness than that of the first silicon substrate 153. That is, the first silicon substrate 153 may have a first thickness T1, and the second silicon substrate 156 may have a thinner second thickness T2 than that of the first thickness T1. Thus, upper and lower lengths of the second through hole 157b may be shorter than that of the first through hole 157a.

Meanwhile, the first through hole 157a and the second through hole 157b may be formed using a one-time wet-etching process. Thus, the wet-etching processes used for formation of the first through hole 157a and the second through hole 157b may be performed in an in-situ scheme by using the same etching solution as each other. In this case, since the first through hole 157a and the second through hole 157b have different shapes from each other, the first silicon substrate 153 and the second silicon substrate 156 may be formed to have different crystal directions from each other, so as to form the discharge channel 157. For example, the first silicon substrate 153 may be a [100] silicon wafer, and the second silicon substrate 156 may be a [110] silicon wafer. The silicon substrates of the multi-layered substrate structure 151 may include at least one of a [100] silicon wafer, a [110] silicon wafer, and a [111] silicon wafer. The coupling order and combination scheme of them may be variously changed and modified according to a desired shape of the discharge channel.

As described above, the inkjet printer head 100 of the present invention is provided with a nozzle package and the nozzle plate 150. The nozzle plate 150 is formed with the first silicon substrate 153 and the second silicon substrate 156 which have different crystal directions from each other, so that it is possible to define the discharge channel 157 with a funnel shape. Thus, in the nozzle plate 150 and the inkjet printer head 100 with the nozzle plate 150 according to the present invention, the discharge channel 157 may be finely formed to have different shapes for each section by using the principle where the first silicon substrate 153 and the second silicon substrate 156 are formed to have different etching surfaces depending on the their crystal directions, so that it is possible to improve a discharge precision of ink.

Continuously, a detailed description will be given of a method for manufacturing the nozzle plate in accordance with an embodiment of the present invention. Herein, the repeated description thereof will be omitted and simplified.

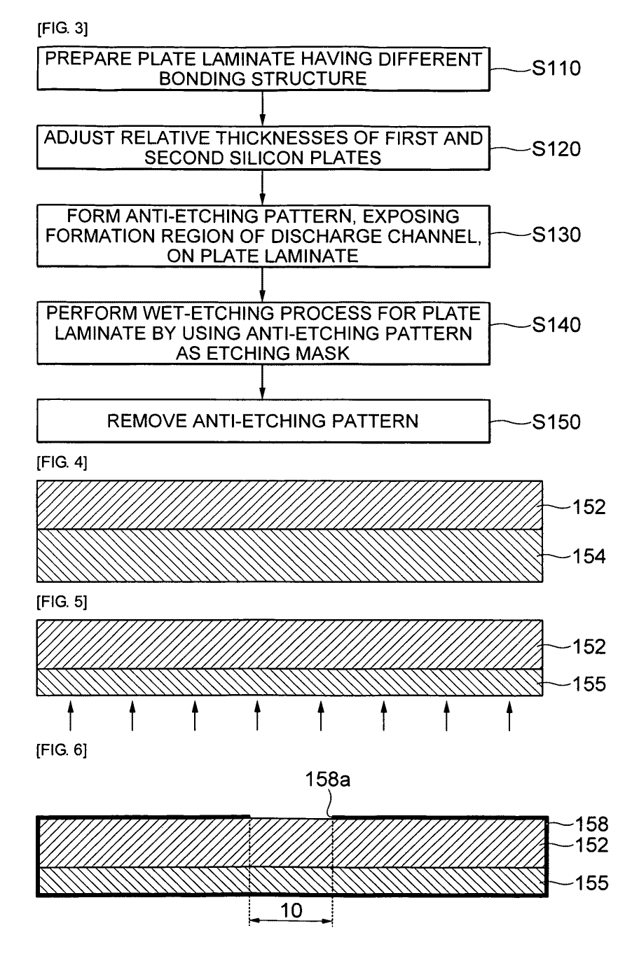

FIG. 3 is a flowchart showing a method for manufacturing the nozzle plate in accordance with an embodiment of the present invention. FIGS. 4 to 9 are view showing a process of manufacturing the nozzle plate in accordance with an embodiment of the present invention, respectively.

Referring to FIGS. 3 and 4, a plate laminate with different bonding structure may be prepared (step S110). For example, the step of preparing the plating laminate may include a step of preparing the first silicon plate 152, a step of preparing the second silicon plate 154, and a step of bonding the first silicon plate 152 to the second silicon plate 154.

Herein, the first silicon plate 152 and the second silicon plate 154 may have different crystal orientations from each other. For one example, [100] silicon wafer may be used as the first silicon plate 152, and the [110] silicon wafer may be used as the second silicon plate 154. Thus, the plate laminate may be formed by stacking the silicon wafers with crystal orientations different from each other.

The step of bonding the first silicon plate 152 to the second silicon plate 154 may be performed by bonding the plate laminate in a Silicon Direct Bonding (SDB) scheme. In this case, there is no need to provide a separate bonding layer between the first silicon plate 152 and the second silicon plate 154. Also, for other example, by interposing a bonding layer between the first silicon plate 152 and the second silicon plate 154, the first silicon plate 152 and the second silicon plate 154 may be bonded to each other. In this case, it is preferable to form the bonding layer to have a thin thickness hardly enough to interrupt the formation of the discharge channel in a formation process of the discharge channel of being a subsequent process.

Referring to FIGS. 3 to 5, the first silicon plate 152 and the second silicon plate 154 may have relative thicknesses (step S120). For example, there may be included the step of processing the substrate laminate in such a manner that the second silicon plate 154 has a thinner thickness than that of the first silicon plate 152. For one example, the step of processing the substrate laminate may include a step of selectively grinding the treated surface of the second silicon plate 154 to thereby manufacture a second silicon plate 155 with a thin thickness. For other example, the step of processing the substrate laminate may include a step of wet-etching or dry-etching selectively the treated surface of the second silicon plate 154. Thus, it is possible to manufacture a plate laminate constituted by the first silicon plate 152 and the second silicon plate 155 thinner than that of the first silicon plate 152.

Referring to FIGS. 3 and 6, an anti-etching pattern 158 for exposing a formation region 10 of the discharge channel may be formed on the plate laminate (step S130). For example, the step of forming the anti-etching pattern 158 may include a step of forming a silicon nitride (SiN) film which covers the plate laminate at a uniform thickness, and a step of forming the opening 158a, which exposes the formation region 10 of the discharge channel of the plate laminate, on the silicon nitride film.

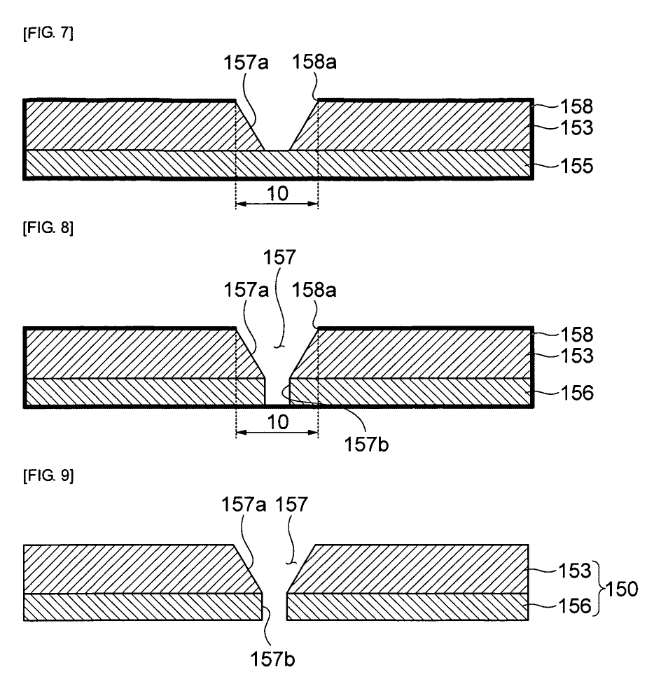

Referring to FIG. 3, and FIGS. 7 and 8, the palate laminate may be subjected to a wet-etching process by using the anti-etching pattern 158 as an etching mask (step S140). The step of performing the wet-etching process may include a step of supplying an etching solution to the plate laminate. As the etching solution, KOH etching solution may be used. The KOH etching solution supplied to the substrate laminate can etch the formation region 10 of the discharge channel of the plate laminate which is exposed through the openings 158a of the anti-etching pattern 158.

In more particular, the first silicon plate (indicated by reference numeral 152 of FIG. 6) is first etched by the supplied etching solution to thereby form the first through hole 157a on the first silicon plate 152. In this case, since the first silicon plate 152 may be a silicon wafer with crystal direction [100], the first through hole 157a may be formed in one of square pillar and cylinder shapes whose cross section gets narrower downwardly, as shown in FIG. 7. The inclination angle of the first through hole 157a may be made through adjustment of an angle at which a single crystal ingot is cut, during a process of preparing the first silicon plate 152 through cutting of the single crystal ingot. Thus, there may be formed the first silicon substrate 153 with the first through hole 157a whose cross section gets narrower downwardly.

Thereafter, by the etching solution, the second silicon plate (indicated by reference numeral 155 of FIG. 7) may be etched by using the first silicon substrate 153 as an etching mask. In this case, as being self-aligned by the first silicon substrate 153, the etching solution may etch a part of the second silicon plate 155 selectively exposed by the first silicon substrate 153. Thus, there may be formed the second through hole 157b with which the first through hole 157a communicates. Herein, since the second silicon substrate 155 is a silicon wafer with a [110] crystal orientation, so the second through hole 157b may be formed in a vertical cylinder shape as shown in FIG. 8. The inclination angle of the second through hole 157b may be made through adjustment of an angle at which the single crystal ingot is cut during a process of preparing the second silicon plate 154 through cutting of the single crystal ingot.

By the above-described process, it is possible to manufacture a bonding structure of the first silicon substrate 153 to the second silicon substrate 156 which define the discharge channel 157 with a funnel shape. The discharge channel 157 may have different shapes for each section. In particular, the discharge channel 157 may have a different shape on the basis of the boundary surface between the first silicon substrate 153 and the second silicon substrate 156, so that it is possible to adjust relative thicknesses of the first and second silicon substrates 153 and 156, thereby adjusting a level which divides section-by-section shapes of the discharge channel 157.

Referring to FIGS. 3 and 9, the anti-etching pattern 158 may be removed (step S150). The step of removing the anti-etching pattern 158 may be made by performing a wet-etching process using an etching solution for selectively etching the anti-etching pattern 158 for the plate laminate.

As described above, according to the method for manufacturing the nozzle plate 100, it is possible to manufacture the multi-layered plate structure 151 with the discharge channel 157 with different shapes for each section, by bonding the first and second silicon substrates 153 and 156 with different crystal orientations from each other. In this case, the structure of the discharge channel 157 may be variously modified through adjustment of crystal orientation and relative thicknesses of the silicon substrates 153 and 156. Thus, according to the method for manufacturing the nozzle plate 100 of the present invention, it is possible to manufacture the nozzle plate 100 with an improved discharge concision of ink, since it is possible to finely form the discharge channel 157 with different shapes for each section by using the principle where the silicon substrates 153 and 156 are formed to have etching surfaces different from each other according to their crystal directions.

The inkjet printer head of the present invention is provided with the nozzle package and the nozzle plate inter-coupled to the nozzle package. In this case, the nozzle plate is constituted by silicon substrates with crystal directions different from each other. Therefore, it is possible to define a discharge channel with different shapes for each section on the basis of a boundary surface between the silicon substrates. Thus, the nozzle plate and the inkjet printer head with the nozzle plate according to the present invention has a discharge channel which is formed to have different shapes for each section therein by using the principle where the silicon substrates are formed to have etching surfaces different from each other according to their crystal directions.

In the method for manufacturing the nozzle plate of the present invention, it is possible to bond the silicon substrates with different crystal directions, thereby manufacturing a multi-layered plate structure with a discharge channel which is formed to be in different shapes for each section therein. In this case, the structure of the discharge channel may be variously modified through crystal directions and relative thicknesses of the silicon substrates. Thus, in the method for manufacturing the nozzle plate, it is possible to manufacture a nozzle plate with a higher discharge precision of ink, since using the principle where the etching surfaces are formed depending on crystal directions of the silicon substrates, a discharge channel is finely formed to have different shapes for each section.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

1. A nozzle plate comprising:
a first silicon substrate; and
a second silicon substrate which has a crystal orientation different from that of the first silicon substrate and is bonded to the first silicon substrate,
wherein the first silicon substrate includes a first through hole, and the second silicon substrate includes a second through hole which the first through hole communicates with, and has a different structure from that of the first through hole.

2. The nozzle plate of claim 1, wherein the first silicon substrate is disposed to be upper than the second silicon substrate, the first silicon substrate being a [100] silicon wafer, and the second silicon substrate being a [110] silicon wafer.

3. The nozzle plate of claim 1, wherein the first through hole has a pillar shape whose cross section gets narrower downwardly, and the second through hole has the same upper and lower cross sections.

4. The nozzle plate of claim 3, wherein the second silicon substrate has a thinner thickness than that of the first silicon substrate.

5. The nozzle plate of claim 1, wherein the first through hole and the second through hole are structured to be in a funnel shape.

6. The nozzle plate of claim 1, further comprising a bonding layer interposed between the first silicon substrate and the second silicon substrate.

7. A nozzle plate comprising:
a first silicon substrate;
a second silicon substrate which has a crystal orientation different from that of the first silicon substrate and is bonded to the first silicon substrate; and
a discharge channel which passes through the first and second silicon substrates and has mutually different shapes with respect to a boundary surface between the first and second silicon substrates.

8. The nozzle plate of claim 7, wherein the first silicon substrate is a [100] silicon wafer, and the second silicon substrate is a [110] silicon wafer.

9. The nozzle plate of claim 7, wherein the discharge channel comprises:
a first through hole which is formed through the first silicon substrate and has a cross section getting narrower downwardly; and
a second through hole which is formed through the second silicon substrate, and communicates with the first through hole and has the same upper and lower cross sections.

10. The nozzle plate of claim 7, wherein the second silicon substrate has a thinner thickness than that of the first silicon substrate.

11. The nozzle plate of claim 7, wherein the discharge channel comprises:
a first thorough hole which is formed through the first silicon substrate; and
a second through hole which is formed through the second silicon substrate, and communicates with the first through hole,
wherein the first and second through holes are structured to be in a funnel shape.

12. A method for manufacturing a nozzle plate comprising:
preparing a plate structure by bonding silicon plates with mutually different crystal orientations;
forming an anti-etching pattern, which exposes a desired region for formation of a discharge channel, on the plate structure;
forming the discharge channel on the plate structure by performing a wet-etching process using the anti-etching pattern as an etching mask; and
removing the anti-etching pattern.

13. The method of claim 12, wherein preparing the plate structure comprises:
preparing a first silicon plate with a [100] crystal orientation;
preparing a second silicon plate with a [110] crystal orientation; and
bonding the first silicon plate to the second silicon plate.

14. The method of claim 12, wherein preparing the plate structure comprises:
preparing the first and second plates with mutually different crystal orientations from each other; and
bonding the first and second silicon plates in a Silicon Direct Bonding (SDB) scheme.

15. The method of claim 12, wherein preparing the plate structure comprises bonding the silicon plates by using a bonding layer interposed therebetween.

16. The method of claim 12, wherein forming an anti-etching pattern comprises:
forming a silicon nitride film which covers the plate structure; and
selectively removing the silicon nitride film on a desired region for formation of the discharge channel.

17. The method of claim 12, wherein forming the discharge channel comprises:
providing a first through hole formed through a silicon plate which is disposed to be upper among the silicon plates constituting the plate structure; and
providing a second through hole formed through a silicon plate which is disposed to be lower among the silicon plates, the second through hole communicating with the first through hole and having a different structure from that of the first through hole.

18. The method of claim 12, wherein forming the discharge channel comprises forming a through hole with a funnel shape which penetrates the plate structure.

19. The method of claim 12, wherein preparing the preparing the plate structure comprises:
preparing a first silicon plate with a [100] crystal orientation; and
preparing a second silicon plate with a [110] crystal orientation,
wherein the step of forming the discharge channel comprises the steps of:
providing a first through hole formed through the first silicon plate, the first through hole having a cross section which gets narrower downwardly; and
providing a second through hole formed through the second silicon plate, the second through hole communicating with the first through hole and having the same upper and lower cross sections.

20. The method of claim 12, wherein forming the discharge channel comprises:
providing the first through hole which is formed through a silicon plate which is disposed to be upper from the silicon plates constituting the plate structure in such a manner that a silicon plate disposed to be relatively low is exposed; and
providing the second through hole which is formed through the lower-disposed silicon plate to communicate with the first through hole, by using the upper-disposed silicon plate as an etching mask.

21. The method of claim 12, wherein preparing the plate structure comprises adjusting relative thicknesses of the silicon plates, and adjusting the relative thicknesses of the silicon plates including grinding at least one of the silicon plates.

22. The method of claim 12, wherein forming the discharge channel comprises supplying an etching solution which etches the plate structure to be anisotropic.

23. The method of claim 22, wherein supplying the etching solution comprises supplying a KOH etching solution, the KOH etching solution etching the plate structure in such a manner that the anti-etching pattern covering a lower surface of the plate structure is exposed.

24. The method of claim 22, wherein forming the discharge channel comprises:
providing the first through hole formed through the upper-disposed silicon plate, by etching the silicon plate which is disposed to be upper from the silicon plates of the plate structure; and
providing the second through hole formed through the lower-disposed silicon plate from the silicon plates as the etching is self-aligned by the upper-disposed silicon plate.

25. A method for manufacturing a nozzle plate comprising:
preparing a plate structure constituted by silicon pates with mutually different crystal orientations; and
forming a discharge channel, which has mutually different shapes with respect to a boundary surface between the first and second silicon plates, in the plate structure.

26. The method of claim 25, wherein forming the discharge channel comprises:
forming an anti-etching pattern which exposes a desired region for formation of the discharge channel, on the plate structure; and
performing a wet-etching process which uses the anti-etching pattern as an etching mask.

27. The method of claim 25, wherein the discharge channel includes a upper channel and a lower channel whose shapes are different from each other, forming the discharge channel comprising defining a boundary between the upper and lower channels, and defining the boundary between the upper and lower channels being made by adjustment of relative thicknesses of the silicon plates.

28. The method of claim 25, wherein the plate structure comprises a first silicon plate and a second silicon plate which are boned one on the other, forming the discharge channel comprising:
providing a first through hole formed through the first silicon plate, the first through hole having a cross section which gets narrower toward the second silicon plate; and
providing a second through hole formed through the second silicon plate, the second through hole having the same upper and lower cross sections.

29. An inkjet printer head comprising:
a multi-layered plate structure which has spaces for defining supply channels through which ink flows therein;
an actuator disposed on an upper portion of the multi-layered plate structure;
a nozzle plate disposed an lower portion of the multi-layered plate structure,
wherein the nozzle plate comprises:
a first silicon substrate;
a second silicon substrate which has a crystal orientation different from that of the first silicon substrate and is bonded to the first silicon substrate; and
a discharge channel which passes through the first and second silicon substrates and has mutually different shapes with respect to a boundary surface between the first and second silicon substrates.

30. The inkjet printer head of claim 29, wherein the first silicon substrate is a [100] silicon wafer, and the second silicon substrate is a [110] silicon wafer.

31. The inkjet printer head of claim 29, wherein the first silicon substrate has a first through hole having cross section which gets narrower downwardly, and the second silicon substrate has a second through hole which communicates with the first through hole and has the same upper and lower cross sections.

32. The inkjet printer head of claim 29, wherein the first silicon substrate includes a first through hole for defining an upper channel of the discharge channel, and the second silicon substrate includes a second through hole for defining a lower channel of the discharge channel, wherein the first and second through holes are formed in a funnel shape and communicates with each other.

33. The inkjet printer head of claim 29, wherein any one substrate disposed to be relatively low in the first and second silicon substrates has a thin thickness.
